(19) United States
(12) Patent Application Publication
(10) Pub. No.: US 2010/0066710 A1
(43) Pub. Date: Mar. 18, 2010

(54) NAIL CHIP MOUNTED WITH IMAGE DISPLAY DEVICE AND DEDICATED CHARGER

(76) Inventor: Michio Koibuchi, Tokyo (JP)

Correspondence Address: KRATZ, QUINTOS & HANSON, LLP, 1420 K Street, N.W., Suite 400, WASHINGTON, DC, 20005, US

(21) Appl. No.: 12/447,993

(22) PCT Filed: Oct. 31, 2007
(86) PCT No.: PCT/JP2007/071262

§ 371 Date: May 26, 2009

(30) Foreign Application Priority Data
Nov. 1, 2006 (JP) JP2006/321872

(51) Int. Cl. G09G 5/00

(52) U.S. Cl. 345/205

(57) ABSTRACT

[Problems] To provide a nail chip that is self-luminous in the dark so as to vividly illuminate the fingertip there without wasting a paint and remover for use on nail, or container thereof, etc.

[Means for Solving Problems] A laminate comprising at least a circuit substrate mounted with a memory which stores of inputted or received image data and with an arithmetic part for arithmetic operation of the image data and outputting of the results; a display device which displays an image in accordance with the data outputted by the arithmetic part; and a battery which supplies electric power to the circuit and the display device. The laminate is formed into a nail configuration having the display device as an integumentary layer.

### TECHNICAL FIELD

The present invention relates to a nail chip mounted on nails of hands and feet, and particularly to a nail chip mounted with a display device which reproduces and displays image data.

### BACKGROUND ART

Many women decorate the fingertips by drawing a picture or attaching jewelry on their nails by themselves or others, and the decorating operation is called nail art. A so-called nail salon where the nail art is exclusively performed tends to increase in number. Meanwhile, without applying pigment directly to the nails, many people easily enjoy the nail art by applying a nail chip (so called an artificial nail), previously applied with coloring and decoration, onto their nails, because the design of the nail chip can be easily changed.

In general, the conventional nail chip has been supplied to the market in such a state that arbitrary decoration is applied to a thermosetting resin, such as plastic, formed into the shape of a nail. However, in order to enhance the degree of freedom of design selection by users, there has been proposed a technique in which an image accumulated in a database or an image drawn by a user through data input means is output as data to be printed on a nail (see, Japanese Patent Application Laid-Open No. 2000-194838).

However, when the design of nails is changed, the behavior of a user is significantly limited until paint applied to the nails is dried. Further, there is a concern about the harmful impact of paints, removers, and drying agents, used for nails, on human bodies or the impact of the mass production and waste of them on a natural environment.

Further, the paints for nail art such as enamel paint and acrylic paint containing pigments is originally based on the assumption of coloring in a bright place such as under natural light, and therefore, the decoration effect can be hardly exercised under weak light conditions such as nighttime.

### DISCLOSURE OF THE INVENTION

### Problems to be Solved by the Invention

The invention has been made in view of the above problems of the conventional nail art, and a first object of the invention is to provide a nail chip, which can vividly illuminate a fingertip by self-emission, even under dark conditions, without discharging wastes such as paints and removers used for nails or containers thereof.

A second object of the invention is to provide an accessory which can be used with the nail chip, store a large amount of data on the design of nails, and send and receive the data to and from the nail chip.

A third object of the invention is to provide a dedicated charger which can easily charge the nail chip.

A fourth object of the invention is to provide an image data distribution system for a nail chip for easily obtaining and changing new image data by using the nail chip and the accessory.

### Means for Resolving the Problems

In order to achieve the first object, a nail chip of the invention is includes a laminate, which is formed into a nail configuration with a display device as an integumentary layer and includes at least a circuit substrate mounted with a memory which stores input or received image data, an arithmetic part which applies arithmetic operation to the image data, and an output part which outputs the image data, the display device which displays an image based on data output from the arithmetic part, and a battery which supplies an electric power to the circuit and the display device.

The nail chip of the invention further includes at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit and the display device. The nail chip is obtained by cutting a plate-like laminate, including the display device as an integumentary layer, into the approximately shape in plan view of a nail, and is formed into the shape of the nail when mounted.

In the invention, an organic electroluminescence display (hereinafter also referred to as an organic EL display) or an organic light emitting diode display (OLED) may be used as the display device. An organic radical battery may be used as the battery.

Further, in the invention, the integrated circuit has a wireless communication function, whereby the image data downloaded from a terminal equipment such as a personal computer or a portable telephone through a network such as internet is received to be displayed on the display device, or the image data stored in the memory can be mutually transmitted and received between users wearing the nail chips of the invention.

The nail chip of the invention is preferably configured so as to include an adjustment margin, which can be removed in, for example, the root side, the front end side, and the left and right sides by trimming, cutting, or bending so as to match the shape of each nail of a user wearing the nail chips. According to this configuration, any user can easily mount the nail chip on the nail with no space therebetween, regardless of age and gender.

The laminate constituting the nail chip of the invention includes an adhesive member and a release sheet on the lowermost layer, or can be integrally formed with a seal material including on at least one side the adhesive member and the release sheet.

In order to achieve the second object, an accessory of the invention, such as a ring, a necklace, a bracelet, and a bangle, is used with a nail chip. The nail chip includes a laminate, which is formed into a nail configuration with a display device as an integumentary layer and includes at least a circuit substrate mounted with a memory which stores input or received image data, an arithmetic part which applies arithmetic operation to the image data, and an output part which outputs the image data, the display device which displays an image based on data output from the arithmetic part, and a battery which supplies an electric power to the circuit and the display device. Another nail chip includes at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit and the display device. This nail chip is obtained by cutting a plate-like laminate, including the display device as an integumentary layer, into the approximately shape in plan view of a nail, and is formed into the shape of the nail when mounted. The accessory includes a storage part which obtains and stores the image data and providing means which provides the stored image data to the memory.

In order to achieve the third object, a charger of the invention is used for charging the battery of a nail chip. The nail chip includes a laminate, which is formed into a nail configuration with a display device as an integumentary layer and includes at least a circuit substrate mounted with a memory which stores input or received image data, an arithmetic part which applies arithmetic operation to the image data, and an output part which outputs the image data, the display device which displays an image based on data output from the arithmetic part, and a battery which supplies an electric power to the circuit and the display device. Another nail chip includes at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit and the display device. This nail chip is obtained by cutting a plate-like laminate, including the display device as an integumentary layer, into the approximately shape in plan view of a nail, and is formed into the shape of the nail when mounted. The charger for a nail chip includes a charger body obtained by forming a hard material, such as a synthetic resin, into a suitable columnar shape such as a cylindrical column or a rectangular column, 5 to 10 finger-holes bored in an upper surface of the charger body, and electric power supply means which charges the battery by supplying an electric power to the battery at the bottom of the finger-hole in a contact or non-contact manner.

In order to achieve the fourth object, an image data distribution system for a nail chip of the invention includes a server computer, a nail chip, and an accessory. The nail chip includes a laminate, which is formed into a nail configuration with a display device as an integumentary layer and includes at least a circuit substrate mounted with a memory which stores input or received image data, an arithmetic part which applies arithmetic operation to the image data, and an output part which outputs the image data, the display device which displays an image based on data output from the arithmetic part, and a battery which supplies an electric power to the circuit and the display device. Another nail chip includes at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit and the display device. This nail chip is obtained by cutting a plate-like laminate, including the display device as an integumentary layer, into the approximately shape in plan view of a nail, and is formed into the shape of the nail when mounted. The accessory such as such as a ring, a necklace, a bracelet, and a bangle is used with the nail chip and includes a storage part which obtains and stores the image data and providing means which provides the stored image data to the memory. The server computer, the nail chip, and the accessory are connected through a network in a wired or wirelessly manner. The image data distribution system for a nail chip is characterized in that: the server computer includes a database in which the image data is stored, receiving means which receives a request from the accessory, and transmission means which transmits the image data to the accessory according to the request; the accessory includes input means which inputs a request for the server computer, transmission means which transmits the request to the server computer, receiving means which receives the image data, and the storage part; and the accessory provides the image data in the storage part to the memory by means of the providing means, and the display device displays an image for the relevant image data.

### ADVANTAGEOUS EFFECT OF THE INVENTION

In the nail chip of the invention, the display device is mounted on the surface layer, whereby the image data of the design of nails recorded in the memory is displayed by self-emission, and the nail design can be easily changed by switching or rewriting the reproduced image data. The accessory used with the nail chip can store a large amount of the image data in the storage part. According to the dedicated charger for the nail chip, the battery can be charged while a user wears the nail chips. According to the image data distribution system for a nail chip, a user can easily change the nail design or download and obtain the new image data from a server, regardless of time and place. Accordingly, the fingertips can be brightly lighted in a dark place where light does not reach, and, at the same time, the design image can be displayed or changed without using any paint. Further, when a user wears the nail chips and the accessory, the user can carry a large amount of the image data of nails without spoiling her beauty. Furthermore, since the nail design is given and received as the image data, a natural environment can be completely prevented from being impaired due to discharged waste.

### BEST MODE FOR CARRYING OUT THE INVENTION

Next, an embodiment of the invention will be described with reference to the drawings.

FIG. 1 is an exploded perspective view showing an example of a nail chip of the invention.

FIG. 2 is a system block diagram of an integrated circuit constituting the invention.

FIG. 3 is a perspective view showing an example of the conventional nail art device.

FIG. 4 is a longitudinal cross-sectional view showing an example of the nail chip of the invention having a coating layer.

FIG. 5 is a longitudinal cross-sectional view exemplifying a laminate constituting the nail chip of the invention according to claim 8.

FIG. 6 is a perspective view exemplifying the nail chip of the invention according to claim 9.

FIG. 7 is a transverse cross-sectional view of FIG. 6.

FIG. 8 is a view showing an example of use of the nail chips of the invention and accessories used with the nail chip.

FIG. 9A is a perspective view showing a dedicated charger for a battery constituting the nail chip of the invention.

FIG. 9B is a perspective view showing an example of use of the dedicated charger.

FIG. 10 is a system block diagram exemplifying an image data distribution system according to the invention.

In the conventional nail art device 4, design data in a database or design data input by a user is displayed on a monitor 41 to be printed on a fingernail portion of the user inserted from an insertion opening 42. In the nail art device 4, paint is automatically applied onto the fingernail portion of the user based on image data obtained by digitizing a design image, and the design image is printed on the fingernail portion. Therefore, in comparison with the nail art performed by others and a previously decorated nail chip, in the nail art device 4, the degree of freedom of design selection by users is higher, and the nail art is more easily performed.

However, a cost necessary for the nail art device 4 is high, and paint such as enamel paint or acrylic paint is actually jetted to be applied onto the nails, whereby, as described above, the problem of environmental destruction due to wastes cannot be avoided.

In order to solve the above problem, the invention provides a nail chip with an image display device mounted on an integumentary layer. The nail chip will be described with reference to FIGS. 1 to 9.

In FIG. 1, a nail chip N includes an organic EL display 1 and an integrated circuit 2. The integrated circuit 2 controls and manages a reproduction state of image data D displayed on the organic EL display 1. The integrated circuit 2 is provided with an input part I which reads the image data D from outside, a memory M which records and stores the image data D read by the input part I, an arithmetic part C which suitably applies arithmetic operation to the image data D, stored in the memory M, at an appropriate sampling rate, and an output part O which outputs the image data D to the organic EL display 1.

Any type of display can be used as long as it can reproduce and display the image data D; however, a thin display is preferably used in the nail chip N of the invention, and therefore, the organic EL display 1 is used in the present embodiment.

In the present embodiment, the organic EL display 1 is a display device for displaying an image by using a phenomenon called electroluminescence where electricity is converted into light, and has characteristics of small power consumption, unlike a cathode-ray tube, and being easily thinned because it emits light by itself without requiring a backlight. Further, the organic EL display 1 is in a so-called solid state where a light emitting cell is composed of solid, and therefore, a flexible member like a thin plastic is used as a substrate, whereby the organic EL display 1 can be used as a flexible display. It is not difficult to form or mold such a flexible display into the shape of a nail.

There are products specifically applicable to the organic EL display 1, such as the organic EL displays ALE251 and ALE269 from SANYO Electric Co., Ltd. and the organic EL display AM550L from Eastman Kodak Company. Incidentally, “organic light emitting diode display” is a general name of the organic EL display 1 in Europe and the United States.

The image data D reproduced by the organic EL display 1 may be composed of or include character information, and needless to say may be a moving image data file D.

An electric power used in the organic EL display 1 and the integrated circuit 2 is supplied by a battery 3. In the present embodiment, an organic radical battery is used as the battery 3.

The organic radical battery is a rechargeable battery which includes an organic radical compound as an active material (a storage material) and charges and discharges using the oxidation and reduction reaction of radical. The organic radical battery is a thin flexible battery constituted of an electrode P0 (not shown) formed into a thin film and a penetrating gel-shaped electrolyte. The organic radical battery has a small risk of heating, smoking, and firing even in abnormal situations and thus is excellent in safety, whereby the organic radical battery is most preferably used as the battery 3 included in the nail chip N of the invention. Further, the organic radical battery has an infinitely larger electromotive force than the conventional solar battery and exerts a specific and advantageous effect by being used in the nail chip N of the invention. Furthermore, the organic radical battery does not contain harmful substances such as mercury, lead, and cadmium, and thereby contributing to environment conservation which is one of the objects to be achieved by the invention.

Any type of battery can be used as long as it can ensure electric power, and the battery 3 is not limited to a rechargeable battery.

The battery 3 is preferably charged by a dedicated charger R. As shown in FIGS. 9A and 9B, the charger R is provided with a charger body B in which a suitable hard material having a shape retaining property like a synthetic resin material such as plastic is formed into a substantially columnar shape, finger-holes H bored in an upper surface F of the charger body B, and electric power supply means C for supplying an electric power to the battery 3 at the bottom of the finger-hole H. It is preferable that 5 to 10 finger-holes H are provided in one charger R, and according to this constitution, the electric power can be supplied to all the nail chips N mounted on nails on a single charge.

The electric power supply means C may supply the electric power in a contact or non-contact manner. In the present embodiment, terminals P1 which are in contact with the thin film electrode P0 of the battery 3 to supply the electric power are arranged at the bottom of the finger-holes H. A user inserts each finger wearing the nail chip N through the finger-holes H, whereby the battery 3 is charged. The finger-hole H is formed into a substantially cylindrical shape having a diameter that allows insertion of a finger of a human hand, and it is preferable that a finger hole Ht for a thumb with a slightly larger diameter than the finger-holes His bored. The charger R has an insertion opening J matching a power adaptor Rj for a general portable telephone, and therefore, the power adaptor Rj for a portable telephone can be used for the charger R, leading to greater convenience.

As shown in FIG. 1, the nail chip N of the invention has at least the organic EL display 1 formed into the shape of a nail, the integrated circuit 2, and the battery 3. These components are engaged with each other by an engagement member or adhered with each other through, for example, an adhesive to provide an integrated stacked structure L. An image may be displayed on the organic EL display 1 so as to be observed from outside, and therefore independently of a vertical positional relationship between the integrated circuit 2 and the battery 3 provided under the organic EL display 1. Further, as shown in FIG. 4, a transparent coating layer G for protecting a display surface of the organic EL display 1 may be arbitrarily provided around the organic EL display 1.

The nail chip N of the invention can be configured so as to have an adjustment margin F, which can be removed in any or all of the root side (finger side), the front end side (nail tip side), and the left and right sides by trimming, cutting, or bending so as to match the shape of each nail of a user wearing the nail chips N. The nails of human beings have infinite variety in their width and shape of the root; however, according to this constitution, a user can extremely easily wear the nail chips N on her nails with no space therebetween.

A laminate L can be configured so as to include an adhesive member U and a release sheet T provided on a mount surface being in contact with the nail of the user. According to this constitution, when the user wears the nail chips N, she can easily apply the nail chips N onto her nails at low cost only by peeling the release sheet T from the nail chips N. Further, after use, the nail chips N can be removed without using a chemical agent such as a remover. The laminate L is formed of a material having a suitable plasticity, whereby the nail chip N can be applied onto a curved nail with no space therebetween without requiring a special work.

For the adhesive member U and the release sheet T of the laminate L, as shown in FIGS. 6 and 7, a seal material V having on one side the adhesive member U and the release sheet T is preferably used. When the seal material V is used, a sheet of the nail chips N is stored or carried until being applied onto the user's nails. The sheet of the nail chips N becomes the size of nails when used, and thus, there is little possibility that the nail chips N are scattered and lost by being transported.

As shown in FIG. 2, a receiving part R, which can receive the image data D transmitted from, for example, a terminal by wireless communication means such as Bluetooth, can be mounted on the integrated circuit 2. According to this constitution, the image data D is downloaded from the pattern of the design of nails, accumulated in a database DB such as a server Sc, through internet, to be wirelessly received from a terminal such as a personal computer Pc or a portable telephone Pd, and to be displayed on the display 1 through the output part O, whereby the nail design can be easily changed regardless of time, place, and the presence of equipments.

Further, a transmission part S which can wirelessly transmit the image data D stored in the memory M is mounted on the integrated circuit 2, whereby the image data D displayed on the display 1 or stored in the memory M can be shared between close friends by mutually transmitting and receiving the image data D.

Furthermore, it is effective to use an accessory A, such as a ring rg, a necklace nk, a bracelet br, an anklet ak, and a bangle bg, with the nail chip N of the invention. The accessory A includes a storage part Am which obtains and stores the image data D and providing means Ap for providing the stored image data D to the memory M. When the accessory A is used with the nail chip N, a user can store and carry a plurality of image data D, which cannot fit into the memory M of the nail chip N, by using the storage part Am of the accessory A.

When the nail chip N and the accessory A are used together, a system for distributing the image data D for the nail chip N can be configured. In the image data distribution system, as shown in FIG. 10, the server computer Sc is connected to the accessory A and the nail chip N through a network.

The user of the nail chip N selects a desired design from the image data D (or the information of the image data D) accumulated in the database DB in the server Sc and inputs a request through input means Ai of the accessory A used with the nail chip N to send the request from a transmission means As to the server Sc in order to download the desired image data D.

The server Sc having received the request by receiving means Scr transmits the image data D desired by the user through transmission means Scs, and the accessory A receives the image data D by receiving means Ar to store the image data D in the storage part Am. The user suitably selects the design of nails from the collected image data D in the storage part Am according to need, and the necessary image data D can be provided from the transmission means As to the memory M through the input part I or the receiving part R of the nail chip N. As described above, the image data D obtained in the memory M is output to the display 1 to be displayed as an image. Since new image data D can be always taken from the server Sc, a user can then and there display the new image data D at hand. Note that a portable telephone may be used as the accessory A.

### INDUSTRIAL APPLICABILITY

As described in the above embodiment, a display device is mounted on the surface layer of a laminate, whereby the design of nails as image data stored in a memory is displayed on the display device by self-emission, and the nail design can be easily changed by switching or rewriting the image data. Accordingly, a fingertip can be brightly decorated even in a dark place where light does not reach. Further, since paints are not required to be used at all, a natural environment can be completely prevented from being impaired due to discharged waste. Therefore, this constitution is extremely effective for a nail chip.

### BRIEF DESCRIPTION OF THE DRAWINGS

FIG. 1 is an exploded perspective view showing an example of a nail chip of the invention;

FIG. 2 is a system block diagram of an integrated circuit constituting the invention;

FIG. 3 is a perspective view of the conventional nail art device;

FIG. 4 is a longitudinal cross-sectional view showing an example of the nail chip of the invention having a coating layer;

FIG. 5 is a longitudinal cross-sectional view exemplifying a laminate constituting the nail chip of the invention according to claim 8;

FIG. 6 is a perspective view exemplifying the nail chip of the invention according to claim 9;

FIG. 7 is a transverse cross-sectional view of FIG. 6;

FIG. 8 is a view showing an example of use of the nail chips of the invention and accessories used with the nail chip;

FIG. 9A is a perspective view showing a dedicated charger for a battery constituting the nail chip of the invention;

FIG. 9B is a perspective view showing an example of use of the dedicated charger; and

FIG. 10 is a system block diagram exemplifying an image data distribution system according to the invention.

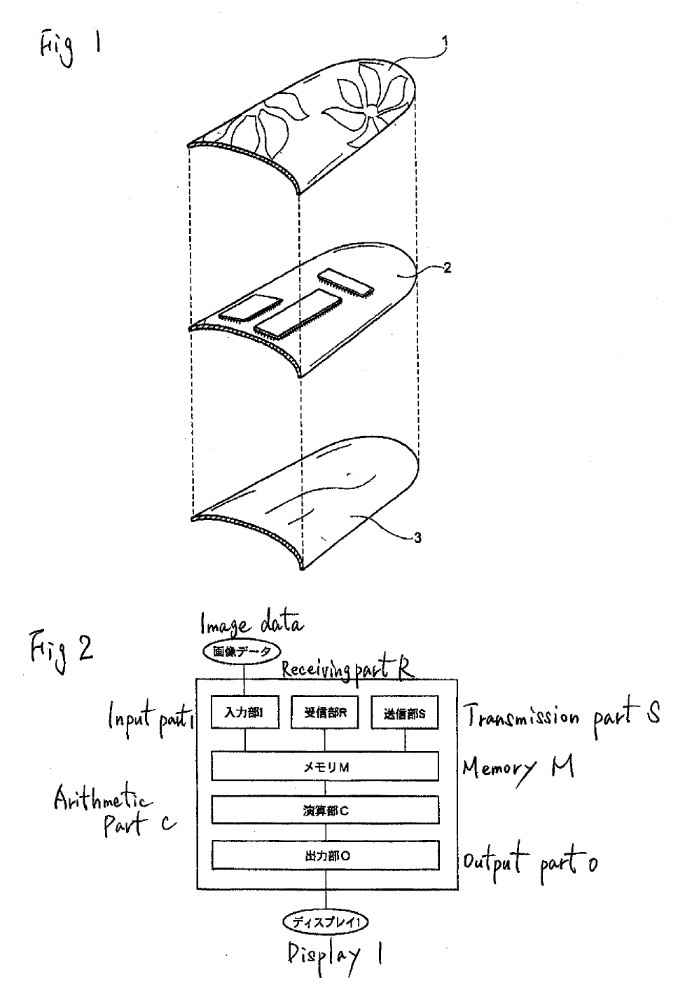

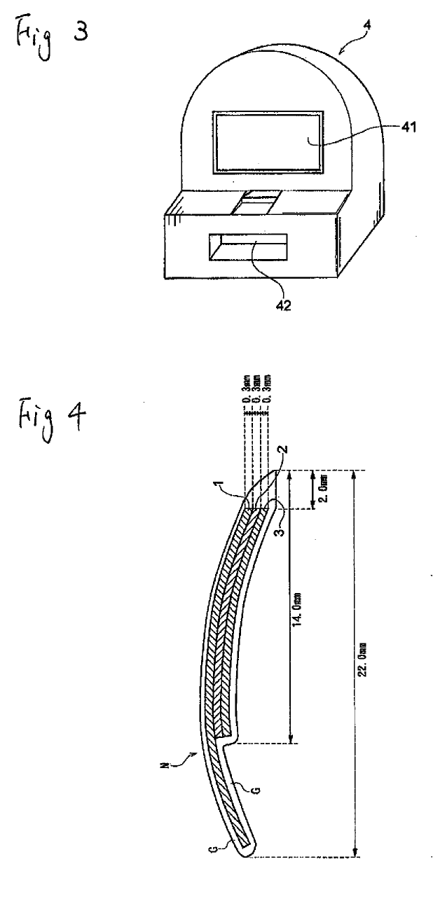

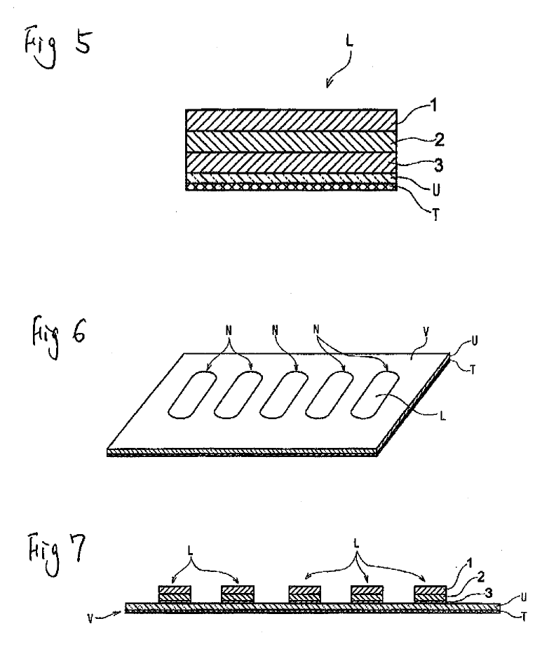

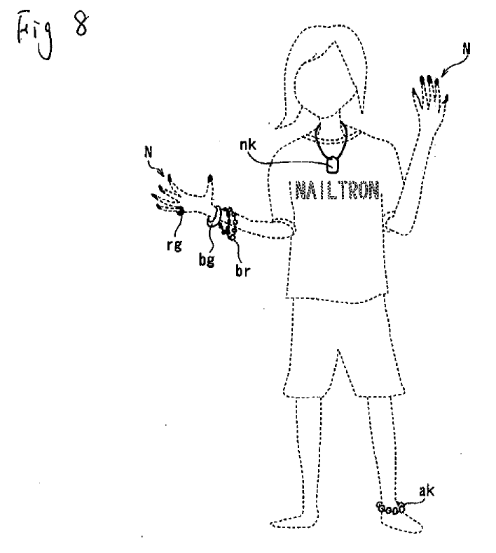

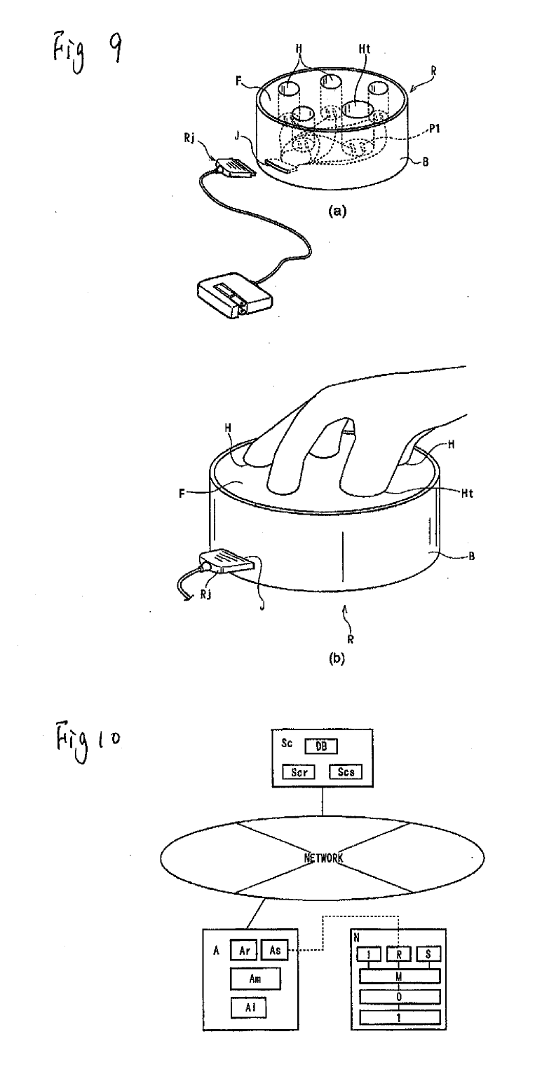

### DESCRIPTION OF REFERENCE NUMERALS

1 Display
2 Integrated circuit
3 Battery
4 Nail art device
41 Monitor
42 Insertion opening
I Input part
R Receiving part
S Transmission part
M Memory
R Arithmetic part
O Output part
N Nail chip
G Coating layer
U Adhesive layer
T Release sheet
V Seal material
L Laminate
A Accessory
rg Ring
bg Bangle
br Bracelet
ak Anklet
nk Necklace
Ar Receiving means
As Transmission means
Am Storage part
Ai Input means
Sc Server computer
DB Database
Ssc Transmission means
Scr Receiving means
R Charger
B Charger body
H Finger-hole
Ht Finger-hole for thumb
F Upper surface of main body
J Adaptor insertion opening
Rj Adaptor
P0 Thin film electrode
P1 Terminal

1. A nail chip comprising a laminate, which is formed into a nail configuration with a display device as an integumentary layer, comprises a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit substrate and the display device.

2. A nail chip comprising: a circuit substrate mounted with a memory which stores input or received image data, an arithmetic part which applies arithmetic operation to the image data, and an output part which outputs the image data; a display device which displays an image based on data output from the arithmetic part; and a battery which supplies an electric power to the circuit substrate and the display device, wherein the nail chip is obtained by cutting a plate-like laminate, comprising the display device as an integumentary layer, into the approximately shape in plan view of a nail, and is formed into the shape of the nail when mounted.

3. The nail chip according to claim 2, wherein the display device is an organic electroluminescence display or an organic light emitting diode display.

4. The nail chip according to claim 2, wherein the battery is an organic radical battery.

5. The nail chip according to claim 2, wherein a receiving part which can receive image data transmitted by wireless communication means such as Bluetooth (registered trademark) is mounted on the circuit substrate.

6. The nail chip according to claim 2, wherein a transmission part which can transmit the image data, stored in the memory, by the wireless communication means such as Bluetooth is mounted on the circuit substrate.

7. The nail chip according to claim 2, wherein an adjustment margin, which can be removed in any or all of a root side, a front end side, and left and right sides by trimming, cutting, or bending so as to match the shape of nails.

8. The nail chip according to claim 2, wherein the laminate comprises on its mounting surface an adhesive member and a release sheet.

9. The nail chip according to claim 8, wherein the adhesive member and the release sheet are integrally formed with a seal material comprising on one side the same adhesive member and release sheet.

10. An accessory such as a ring, a necklace, a bracelet, and a bangle used with a nail chip comprising a laminate, which is formed into a nail configuration with a display device as an integumentary layer and comprises at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit substrate and the display device, or a nail chip, which comprises at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit substrate and the display device, is obtained by cutting a plate-like laminate, comprising the display device as an integumentary layer, into the approximately shape in plan view of a nail, and is formed into the shape of the nail when mounted, wherein the accessory comprises a storage part which obtains and stores the image data and providing means which provides the stored image data to the memory.

11. A charger for charging a battery of a nail chip comprising a laminate, which is formed into a nail configuration with a display device as an integumentary layer and comprises at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit substrate and the display device, or a nail chip, which comprises at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit substrate and the display device, is obtained by cutting a plate-like laminate, comprising the display device as an integumentary layer, into the approximately shape in plan view of a nail, and is formed into the shape of the nail when mounted, wherein the charger for a nail chip comprises a charger body obtained by forming a hard material, such as a synthetic resin, into a suitable columnar shape such as a cylindrical column or a rectangular column, 5 to 10 finger-holes bored in an upper surface of the charger body, and electric power supply means which charges the battery by supplying an electric power to the battery at the bottom of the finger-holes in a contact or non-contact manner.

12. An image data distribution system for a nail chip, comprising: a server computer; a nail chip comprising a laminate, which is formed into a nail configuration with a display device as an integumentary layer and comprises at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit substrate and the display device, or a nail chip, which comprises at least a circuit substrate mounted with a memory which stores input or received image data, an arithmetic part which applies arithmetic operation to the image data, and an output part which outputs the image data, a display device which displays an image based on data output from the arithmetic part, and a battery which supplies an electric power to the circuit substrate and the display device, is obtained by cutting a plate-like laminate, comprising the display device as an integumentary layer, into the approximately shape in plan view of a nail, and is formed into the shape of the nail when mounted; and an accessory, such as a ring, a necklace, a bracelet, and a bangle, used with the nail chip and comprising a storage part which obtains and stores the image data and providing means which provides the stored image data to the memory, the server computer, the nail chip, and the accessory being connected through a network in a wired or wirelessly manner, wherein
the server computer comprises a database in which the
image data is stored, receiving means which receives a request from the accessory, and transmission means which transmits the image data to the accessory according to the request,
the accessory comprises input means which inputs a request for the server computer, transmission means which transmits the request to the server computer, receiving means which receives the image data, and the storage part, and
the accessory provides the image data in the storage part to the memory by means of the providing means, and the display device displays an image for the relevant image data.

13. The nail chip according to claim 1, wherein the display device is an organic electroluminescence display or an organic light emitting diode display.

14. The nail chip according to claim 1, wherein the battery is an organic radical battery.

15. The nail chip according to claim 1, wherein a receiving part which can receive image data transmitted by wireless communication means such as Bluetooth (registered trademark) is mounted on the circuit substrate.

16. The nail chip according to claim 1, wherein a transmission part which can transmit the image data, stored in the memory, by the wireless communication means such as Bluetooth is mounted on the circuit substrate.

17. The nail chip according to claim 1, wherein an adjustment margin, which can be removed in any or all of a root side, a front end side, and left and right sides by trimming, cutting, or bending so as to match the shape of nails.

18. The nail chip according to claim 1, wherein the laminate comprises on its mounting surface an adhesive member and a release sheet.

19. The nail chip according to claim 18, wherein the adhesive member and the release sheet are integrally formed with a seal material comprising on one side the same adhesive member and release sheet.
